(19) United States
(12) Patent Application Publication
(10) Pub. No.: US 2025/0094237 A1
(43) Pub. Date: Mar. 20, 2025

(54) CAPACITY-BASED LOAD BALANCING IN SHARED RESOURCE POOL

(71) Applicant: Microsoft Technology Licensing, LLC, Redmond, WA (US)

(72) Inventors: Wenbin MENG, Bellevue, WA (US); Hemant KUMAR, Bellevue, WA (US); Rakesh KELKAR, Bellevue, WA (US); Karthik RAMAN, Sammamish, WA (US); Sanjay RAMANUJAN, Sammamish, WA (US); Kevin Joseph RIEHM, Woodbury, WA (US); Theodore Dragov TODOROV, Seattle, WA (US)

(21) Appl. No.: 18/470,772

(22) Filed: Sep. 20, 2023

(51) Int. Cl. G06F 9/50

(52) U.S. Cl. CPC G06F 9/505

(57) ABSTRACT

A system provides capacity-based load balancing across model endpoints of a cloud-based artificial intelligence (AI) model. The system includes a consumption determination engine executable to determine a net resource consumption for processing tasks in a workload generated by a client application for input to the trained machine learning model. The system also includes a load balancer that determines a distribution of available resource capacity in a shared resource pool comprising compute resources at each of the multiple model endpoints. The load balancer allocates parallelizable tasks of the workload among the compute resources at the multiple model endpoints based on the net resource consumption of the tasks and on the distribution of available resource capacity in the shared resource pool.

### BACKGROUND

A large language model (LLM) is a type of machine learning model that can be used to perform a variety of natural language processing tasks such as generating and classifying text, answering questions, and translating text from one language to another. Transformer models represent one popular class of machine learning model that are used in a variety of generative artificial intelligence (AI) applications and natural language processing applications. A transformer model is a neural network that learns context and meaning by tracking relationships in sequential data. Examples of transformer-based models include GPT (Generative Pre-trained Transformer), OPT (Open Pretrained Transformer), and Bloom language model (Bioscience Large Open-science Open-access Multilingual). It is common for transformer models to be provided to end customers as cloud-based software services.

Transformer models typically consume significant amounts of memory and in some cases are too large to execute on a single processing node. The amount of memory utilized by each transformer model varies based on the unique characteristics of the model, the specific use of the model (e.g., as influenced by the many different types of input parameters), as well as the size of each workload being processed and the size of text being generated by the model. The immense GPU (graphics processing unit) utilization of these models makes them expensive to operate and creates challenges pertaining to efficient resource management.

### SUMMARY

According to one implementation, a method provides load-balancing of tasks cross various model endpoints of a trained machine learning model. The method includes determining net resource consumption for processing tasks of a workload generated by a client application for input to the trained machine learning model; determining a distribution of available resource capacity across each of the model endpoints; and allocating parallelizable tasks of the workload to compute resources at the multiple model endpoints based on the net resource consumption of the tasks and on the distribution of available resource capacity in the shared resource pool.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that implements client-side capacity-based load balancing of tasks provided to model endpoints of a cloud-based artificial intelligence (AI) model.

FIG. 2 illustrates example load-balancing actions of another system that implements client-side capacity-based load balancing for a cloud-based AI model.

FIG. 3 illustrates example operations for performing capacity-based load balancing among model endpoints of a cloud-based AI model.

FIG. 4 illustrates an example schematic of a processing device suitable for implementing aspects of the disclosed technology.

### DETAILED DESCRIPTION

In existing systems deploying artificial intelligence (AI) models as cloud-based services, it is common for available resources to be pooled at regional data centers and dynamically assigned to cloud tenants on an as-needed basis. When a tenant places a request with a cloud-based model, the request is directed to a select model endpoint executing an instance of the model, such as a model endpoint corresponding to a data center in a same geographical region as the source of the request. As used herein, a “model endpoint” refers to a server hardware, typically implemented on one or multiple virtual machines or servers, that is configured to execute compute logic of a cloud-based model. In one implementation, a model endpoint includes a collection of logical endpoints corresponding to one or more servers or one or more virtual machines executing on servers at a regional data center that are all configured to execute core logic of a same AI model. In some systems, a single server has the capability to operate a plurality of model endpoints for different model instances (e.g., either the same model or different models). In one implementation, a model endpoint is a single instance of a model and the compute hardware supporting execution of that instance.

When a processing request is received at a model endpoint, a quantity of compute capacity is allocated to the individual workload from on-site hardware resources, and this allocated compute capacity counts toward a quota that is allotted to the requested client application. As used herein, compute capacity refers to compute hardware, such as a processors and memory, utilized during the processing of a compute task. In various implementations of the disclosed technology, compute capacity is allocated in units graphics processing units (GPUs) or central processing units and/or (CPUs), which include processing units as well as internal memory (e.g., random access memory (RAM). In some implementations, compute capacity also includes units of memory external to CPUs and GPUs that is accessed in support of CPU and/or GPU-driven processing tasks.

Due to this practice of allocating resources for a workload from geographically-closest model endpoints, available capacity within a regional data center cannot be leveraged by tenants based in other geographical regions requesting the same types of computational tasks from the same AI model. For example, a workload requested by a first client application executing in the western United States cannot be delegated to an endpoint in Asia that is fully equipped to execute the requested task. This regional allocation practice creates pockets of unused model capacity, also referred to as “fragmented capacity,” that are constantly changing.

Another source of fragmented capacity in cloud-based AI model services arises as a consequence of assigning workloads to model endpoints without regard for individual workload characteristics. For example, a model endpoint is selected for a workload without consideration of the size of the workload or for the size of other workload(s) currently being executed by each other model endpoint of the requested cloud-based model. Due to this, it is entirely possible that compute capacity can be quickly saturated (e.g., fully consumed) at one model endpoint (e.g., an individual server or regional data center) while other endpoints—even those receiving identical number(s) of workloads—are not similarly saturated. For example, five large workloads may saturate 98% of available GPU capacity at one model endpoint while five smaller workloads may saturate only 15% of available GPU capacity at another model endpoint with identical hardware and software characteristics. As used herein, a compute resource is said to be consumed at times when the compute resource is allocated to support an active workload and therefore unavailable for allocation to another requesting process. Allocation is typically achieved by way of a reservation that associates particular resources (e.g., GPUs, sticks of RAM) with a particular process, rendering those particular resources unavailable for use by other processes.

The herein disclosed allocation system employs logic for discovering and utilizing available model endpoints anywhere in the world and for allocating compute tasks to select model endpoints based on characteristics of each workload so as to ensure that capacity is saturated approximately equally at all model endpoints executing instances of the model. In various examples included herein, this logic is shown implemented on the client-side, which can yield significant savings to the provider of a cloud-based service operating a trained machine learning model due to reliance on hardware within the user's compute environment (e.g., the user's personal hardware or cloud hardware configured on behalf of the user) to perform tasks on behalf of the AI model service. However, it is to be understand and appreciated that the disclosed logic for endpoint discovery and allocation could be implemented as part of a cloud-based service operating a trained machine learning model, as a cloud-based offering separate from the cloud-based AI model service, or on an edge device in possession of an end user.

According to one implementation, the disclosed resource allocation methodology provides for creating a global pool of compute resources associated with different model endpoints that are available world-wide. All resources in the pool are globally discoverable and available to execute workloads of the model without regard for identity of the requesting process and/or geographic location of the device executing the requesting process. Highly efficient utilization of these globally-available compute resources is realized due to workload-balancing logic that is performed on the client side (e.g., on the device or system that supports that generates and sends the workload to the cloud-based AI model).

The herein-disclosed workload balancing logic is “capacity-based” in that it depends both upon a current distribution of available compute capacity within the global resource pool and also upon the compute capacity that is expected to be consumed by (e.g., allocated to) each individual workload delegated to the resources in the global pool. This capacity that is expected to be allocated to (reserved by) a task or workload is referred to herein as a “net resource consumption,” and can be understood as having both a quantity component and a temporal component. In one implementation, the net resource consumption of a task is given by a number of GPUs reserved to support execution of the task multiplied by the length of time that those GPUs remain “tied up” by the task and unavailable to perform other tasks.

Characteristics of a workload that influence the workload's net resource consumption are referred to herein as resource consumption characteristics—e.g., characteristics that influence a total quantity of compute resources that are needed to execute the task or workload.

According to one implementation, the disclosed load balancing logic allocates parallelizable workload tasks among cloud-based endpoints of a cloud-based AI service, such as a transformer model, in a manner that ensures the net resource consumption of the allocated tasks is distributed across the multiple endpoints within the shared resource pool according to a target allocation distribution. In one implementation, the target allocation distribution is based on (e.g., proportional to) a fractional distribution of the available resource capacity across the multiple endpoints within the shared resource pool. For example, the target allocation distribution ensures that a total (summed) net resource consumption of all tasks(s) delegated from a client to a cloud-based AI service is fractionally distributed across model endpoints in proportion to a distribution of the available resource capacity at those endpoints, even taking into consideration the dynamic fluctuations in that available capacity distribution over time. In other implementations, the net resource consumption of tasks delegated is distributed among the endpoints according to other distribution logic that is based on the available capacity without being necessarily proportional to that distribution. For example, the tasks are distributed to fill unused pockets of capacity in excess of a determined size or to create a distribution among the pockets of a threshold size that mirrors the available capacity distribution within those pockets. Small pockets of capacity are, in some cases, excluded from the distribution (e.g., do not receive tasks). The target allocation distribution may, for various reasons, not be exactly proportional to the distribution of available capacity. For example, the size and number of parallelizable tasks in a workload may not be divisible in a way that precisely matches the target distribution.

The herein disclosed capacity-based load balancing techniques are usable to ensure that cloud-based endpoints of an AI model are, at all times, at approximately equal saturation, without any hotspots (e.g., locations with capacity at or near 100% utilization) that can lead to request failures and job unreliability. Although the disclosed resource allocation system may be implemented to improve resource utilization efficiency in a variety of types of distributed cloud-based systems, particular efficiency gains are realized in systems that offer cloud-based transformer models due to the large quantities of resources that instances of these models consume.

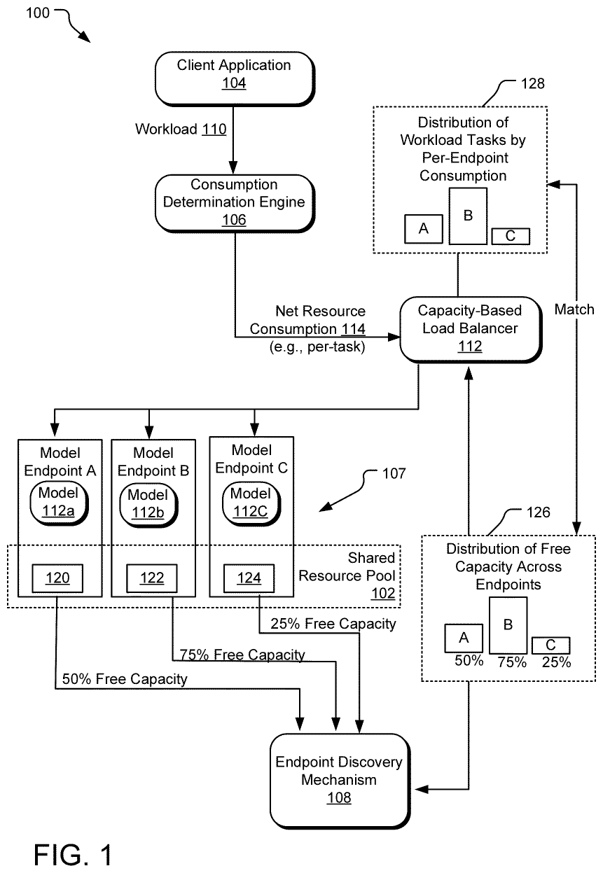

FIG. 1 illustrates an example system 100 that implements capacity-based load balancing of tasks provided to multiple endpoints of a cloud-based AI model offered by a model service 107. In one implementation, the cloud-based AI model is a transformer model trained to perform natural language processing (NLP) tasks.

The system 100 includes an application 104 that generates a workload 110 for execution by the cloud-based AI model. The system further includes a consumption determination engine 106 and capacity-based load balancer 112 that performs actions for allocating tasks of the workload 110 among multiple different endpoints of the cloud-based AI model.

The cloud-based AI model of FIG. 1 is supported by three different model endpoints, labeled A, B, and C, respectively. Each of the three model endpoints A, B, and C includes one or more servers executing instance(s) of the model (e.g., models 112a, 112b, and 112c). Additionally, each of the three model endpoints includes various compute resources 120, 122, 124 (e.g., GPUs and/or CPUs) available to perform compute tasks of the AI model. For example, endpoint A includes a first subset of compute resources 120; endpoint B includes a second subset of compute resources 122, and endpoint C includes a third subset of compute resources 124. These subsets of compute resources 120, 122, and 124 are collectively referred to as a “shared resource pool 102,” and resources from the shared resource pool 102 are used to support different tasks (e.g., transformer model processing tasks) within client-side workloads directed to the model service 107. The shared resource pool 102 includes, for example, groups of servers supporting processing components such as banks of CPUs, GPUs, and memory utilized by those components. It is assumed that various compute resources of the shared resource pool 102 are distributed along the different model endpoints and that the compute resources at each endpoint are available to support the tasks executed by the instance(s) of the trained machine learning model executing at the endpoint where the resources reside.

In addition to the model endpoints A, B, and C executing instances of the cloud-based AI model, the model service 107 further includes an endpoint discovery mechanism 108 that acts as an intermediary for conveying information about the state of the model endpoints A, B, and C back to a capacity-based load balancer 112, that performs load-balancing on behalf of the model service 107. In one implementation, the endpoint discovery mechanism 108 is a cloud-based solution that communicates with an inferencing engine (not shown) executing on each of the multiple model endpoints A, B, and C in the shared resource pool 102. Through such communications, the endpoint discovery mechanism 108 identifies currently-available resource capacity (e.g., unutilized GPU capacity) at each model endpoint. Upon request, this information is provided to a capacity-based load balancer 112.

In addition to the components described above, the system 100 includes a client application 104, a consumption determination engine 106, and a capacity-based load balancer 112. In one implementation, these components all execute within a client compute system, which may be understood as including one or more cloud-based servers (e.g., virtual machines) configured on behalf of the client and/or one or more personal computing devices of the client. In other implementations, one or more of the consumption determination engine 106 and capacity-based load balancer 112 are external to the client compute system.

In general, the client application 104 is an application that generates workloads for execution by the model service 107. In various implementations, the client application 104 serves different functionality and is any of a variety of different types of applications including, for example, an email client, an application for composing text or presentation material, a video chat application, a web-plugin, and more. In some implementations, the client application 104 locally executes on a device of an end user. In other implementations, the client application 104 is a web-based application that serves content for display on the device of an end user.

In one example, the client application 104 is a plug-in tool to a web browser that provides a chat bot service. By providing inputs to a dialog window of the plugin-tool, a user can ask the chat bot questions for natural language processing by the LLM of the model service 107 (e.g., “show me a 7-day itinerary for visiting Paris”). In another example, the client application 104 is a video chat application that includes a user-selectable option for generating a transcript and summarizing portions(s) of a meeting. Here, the summarization tasks are delegated to the model service 107.

The client application 104 provides the workload 110 to a consumption determination engine 106 and the consumption determination engine 106, in turn, identifies individual parallelizable tasks in the workload. As used herein “parallelizable tasks” refers to tasks of a workload that can be performed concurrently and completely independent of one another. If, for example, the workload 110 is a batch request to identifying multiple files that are to be subjected to identical processing, the processing of each individual file is a parallelizable task because such processing can be performed without affecting the processing any other one of the individual files. It is to be appreciated that batch requests represent one of many different types of workloads that include parallelizable processing tasks. The logic for identifying parallelizable tasks of the workload uses rules to identify whether the workload comprises a plurality of portions which may be processed in parallel by different instances of the model since the outcome of processing one of the portions does not influence processing of another one of the portions. In some implementations, the logic for identifying parallelizable tasks includes generating a prompt that is submitted to the model service 107 to suggest portions of the workload which can be parallelized. The prompt is issued to one of the model instances and the results are used to identify portions of the workload to be parallelized.

In another example, the workload 110 is a language translation task that requests translation of a book from English to Chinese. Different paragraphs or sections of the book can be translated in parallel because they have no logical dependence upon one another.

In one implementation, the parallelizable tasks are different files processed in batch processing job. The files are all specified as input to the batch job and identical or substantially identical processing logic is performed on each different file. In other implementations, the consumption determination engine 106 includes logic for identifying parallelizable task of different workloads, such as based on stored and/or learned characteristics of the AI model and/or specific model functions being requested.

After identifying the parallelizable tasks of the requested workload, the consumption determination engine 106 identifies and evaluates resource consumption characteristics to estimate a net resource consumption 114 of each parallelizable task. In one implementation, the workload 110 identifies a workload inputs (e.g., files, parameters) as well as a model identifier (ID) identifying a target model (e.g., the cloud-based AI model served by the model service 107) that is to process the workload. For example, the model ID includes the name of a specific transformer model or API for reaching the model service 107. Based on the model identifier and the workload inputs, the consumption determination engine 106 identifies resource consumption characteristics of the workload corresponding to the workload 110.

In general, resource consumption characteristics are characteristics usable to quantify the resource capacity (e.g., GPU utilization) needed to execute a task or workload. Example capacity consumption characteristics include characteristics of input files identified in the workload 110, such as a size of each file, the amount of data on each file, the type of data in each file, and/or the amount of memory required to read each file. In some implementations, the consumption determination engine 106 further determines resource consumption characteristics of the target model including, for example, the identity of the model, the type or class of model (e.g., generative pre-trained transformer (GBT)), the nature of operations to be performed by the model and/or a memory footprint of the target model when executing over input data with the resource consumption characteristics identified in the workload 110. From this training dataset, the AI model is capable of determining, based on known inputs of a given workload request, the expected memory footprint of the requested AI model when executing over those inputs.

Based on some or all of the above-described resource consumption characteristics of the workload 110, the consumption determination engine 106 outputs a net resource consumption 114 for each parallelizable task of the workload. In various implementations, different metrics are used to quantify the net resource consumption of a given parallelizable task. As will become further apparent from the following description, it is not required that the net resource consumption be defined in terms of compute time for specific hardware component(s). Other units, such as a measurements weighing one or more of the quantity of data processed, quantity of memory or processor capacity, or number of clock cycles to perform processing also suffice. As is described further below, these task-specific net resource consumptions facilitate a fractional division of total workload tasks across the model endpoints that matches a known fractional distribution of available capacity.

In one implementation, the net resource consumption initially determined in terms of “tokens” processed by a transformer model, where the token is the basic unit of text or code that large language models use to process and generate language. For example, a given transformer model task may entail processing 200 tokens, including 50 tokens of input and 150 tokens of output. The net resource consumption is, in this case, given by the compute capacity required to process the 150 input and output tokens, with the conversion between token and resource consumption (e.g., compute resource quantity and time needed to process one token) being known for a given model.

Assume, for example, a first parallelable task of the workload 110 includes inputs that designate text to be processed as input (e.g., one or more text files or specific text strings) and a parameters specifying a length or a maximum length of the requested output (e.g., “max_tokens”). In some scenarios, the client application 104 selects the output length parameter based on the type of model and/or characteristics of the task, such as from a look-up table that stores a maximum recommended output length (e.g., values recommended by the model service 107 or derived based on historical/statistical length data for the model service 107). In other implementations, the output length parameter is set by default to that of a maximum output predesignated as corresponding to the select model and/or task type being performed by the model. Using the designated input text and the parameter specifying the requested output length of max length, the consumption determination engine 106 predicts that processing of the 20 word file is expected to generate an output that is 400 words. The net resource consumption of the first parallelizable task is, in this case, initially represented as 420 tokens, with each word corresponding to one token and there existing a known conversion between 1 token and a given quantity of compute resources consumed in processing the token.

The consumption determination engine 106 repeats this analysis to determine the net resource consumption 114 for each different parallelizable task of the workload 110.

The consumption determination engine 106 outputs the net resource consumption 114 associated with each parallelizable task in the workload to the capacity-based load balancer 112. Upon receipt of such information, the capacity-based load balancer 112 requests capacity distribution information 126 from the endpoint discovery mechanism 108 of the model service 107. In response, the endpoint discovery mechanism 108 communicates with the model endpoints A, B, and C, and discovers a distribution of currently available resource capacity among the multiple endpoints in the shared resource pool 102, such as by retrieving one or more measurements collected at each of the multiple endpoints. For simplicity of the illustrated example, it is assumed that subset of compute resources residing at each model endpoint (e.g., compute resources 120, 122, and 124) are of equal size with identical characteristics. At the time corresponding to FIG. 1, the compute resources 120 at Endpoint A have 50% available capacity; the compute resources 122 at Endpoint B have 75% available capacity; and the compute resource 124 at Endpoint C have 25% available capacity. This fractional distribution of the available resource capacity within the shared resource pool 102 is included in the capacity distribution information 126 conveyed back to the capacity-based load balancer 112.

Upon receipt of the capacity distribution information 126, the capacity-based load balancer 112 determines a target allocation distribution 128 of the parallelizable tasks in the requested workload. In the implementation of FIG. 1, the target allocation distribution 128 is a consumption-based distribution (e.g., based in the net resource consumption of each task) that mirrors the fractional distribution of the available resource capacity across the multiple endpoints within the shared resource pool 102. More specifically, the capacity distribution information 126 illustrates a capacity distribution ratio of 50:75:25, which reduces to a 2:3:1 ratio. In this scenario, the capacity-based load balancer 112 uses the same 2:3:1 ratio for the target allocation distribution 128. The capacity-based load balancer 112 then attempts to allocate the parallelizable tasks of the requested workload among the endpoints A, B, and C such that the net resource consumption of the entire workload is fractionally distributed in a way that is proportion to the capacity distribution ratio reflected in the capacity distribution information 126 (e.g., representing the distribution of the currently available resource capacity among the model endpoints).

If, for example, the requested workload entails 100 parallelizable tasks and the net sum of the net resource consumption of each individual task is 6,000 words (e.g., as in the example above where each word is 1 unit of consumption), the capacity-based load balancer 112 attempts to delegate the tasks among endpoints A, B, and C such that the net resource consumption of task(s) delegated to endpoint A is approximately 2000 words, the net resource consumption of task(s) delegated to endpoint B is approximately 3,000 words, and the net resource consumption of task(s) delegated to endpoint C is approximately 1,0000 words—thus, yielding a 2:3:1 distribution ratio that mirrors the available capacity distribution across the model endpoints.

The capacity-based load balancer 112 then allocates the parallelizable workload tasks among the model endpoints A, B, C based on the target allocation distribution 128. Due to the number of parallelizable tasks and net resource consumption associated with each task in a workload, it may not be possible for the capacity-based load balancer 112 to distribute the parallelizable tasks of each workload in a way that exactly matches the target allocation distribution 128. However, given that the same logic is employed for hundred, thousands, or even millions of requests world-wide, the net effect of this logic is an approximately equal saturation of all of the model endpoints within the model service 107.

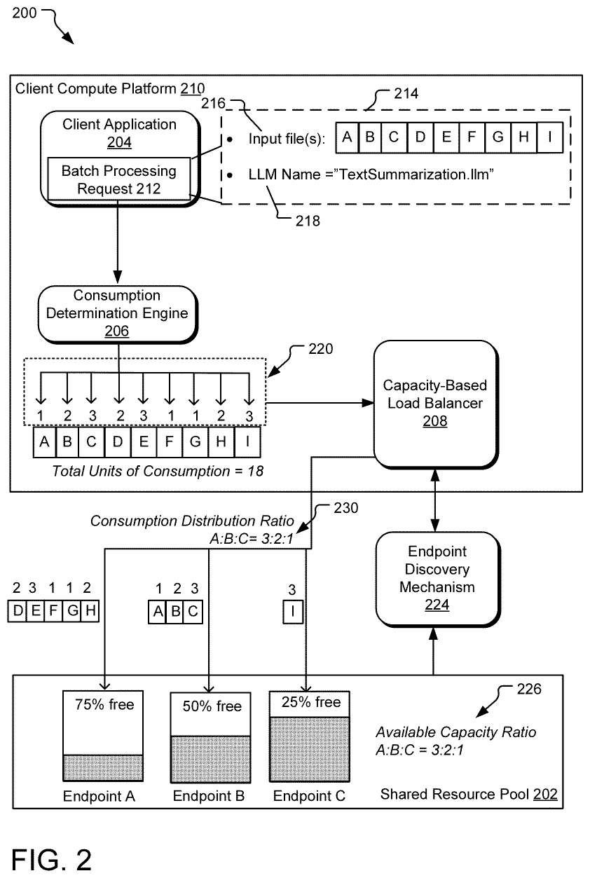

FIG. 2 illustrates example load-balancing actions of another system 200 that implements client-side capacity-based load balancing for a cloud-based AI model. The system 200 is shown including a client compute platform 210 that stores and executes various software components including a client application 204, consumption determination engine 206, and capacity-based load balancer 208. In one implementation, the client compute platform 210 includes cloud hardware and one or more edge devices (e.g., personal devices that communicate with the cloud hardware). In another implementation, the client compute platform 210 is implemented entirely by edge device hardware.

In the illustrated example, the client application 204 generates a batch processing request 212 that requests a set of select processing operations on each of multiple input files 216 (e.g., files annotated as A, B, C . . . I). The batch processing request 212 includes a model ID 218 that uniquely identifies a target cloud-based model that is to receive the batch processing request 212. In the example shown, the model ID 218 is unique identifies an LLM named “TextSummarization.llm” that is trained to perform text summarization tasks. In various implementations, the model ID 218 identifies any of a number of cloud-based LLMs trained to perform different types of NLP tasks. In addition to specifying the model ID 218 and the list of input files 216 that are to be processed, the batch processing request 212 further specifies various model parameters that are usable, by the target cloud-based model, to identify and perform a specific set of requested processing operations.

Notably, the batch processing request 212 is one example of a workload comprising parallelizable tasks. Each individual one of the input files 216 can be processed by the target cloud-based model in a manner than is independent of and, potentially, concurrent to the processing of any other file included in this list.

The batch processing request 212 is provided to consumption determination engine 206 that, in turn, performs actions effective to quantify the net resource consumption of each parallelizable task to be performed during execution of the batch processing request 212. In this example, each parallelizable tasks comprises processing of one of the input files A-I.

To determine the net resource consumption of the first input file (“A”), the consumption determination engine 206 determines a variety of resource consumption characteristics pertaining to the processing of file A such as the size of file “A”, the type of data stored in file A (e.g., image, audio, text), a class of document characterizing file A, the amount of memory required to read file “A,” the type of operations requested from the target cloud-based model, the identity of the target cloud-based model, the class or type of target cloud-based model, the size of outputs requested or expected from the target cloud-based model, and a memory footprint of the target cloud-based model when executed with the parameters specified in the batch processing request 212 on inputs similar in size to file A. In one implementation, the consumption determination engine 206 generates the net resource consumption based on the size of input data (e.g., size of file A) and based on an estimated size of data that is going to be output by the cloud-based model in association with processing the input data, such as by supplying a parameter that sets a cap on the maximum output size. In scenarios where model inputs and outputs include images (e.g., images alone or a combination of images and text to be processed and/or generated), the number of images input and output and the resolution of input/output images net resource consumption cost as well.

Based on some or all of the foregoing resource consumption characteristics, the consumption determination engine 206 assigns a net resource consumption to each individual file named in the batch processing request 212. As explained with respect to FIG. 1, the units of the net resource consumption can be arbitrary provided that the metric facilitates a comparison of the relative amount of capacity consumed via execution of each of the different parallelizable tasks. In one implementation, the net resource consumption of file A is given based on a number of words representing the sum of (1) total words in file A (e.g., the input to the model) and (2) the total number of words that the model is predicted to output based on the processing of file A. For example, the net resource consumption of a task is represented in “tokens,” where processing one word is equivalent to one token, and the processing certain punctuation marks, non-English language characters, and emojis each correspond to a variable (e.g., predefined) numbers of tokens. In other implementations, the net resource consumption of a task is defined terms of predicted processing time for a given hardware component or collection of hardware components.

For illustration of concept, FIG. 2 illustrates a net resource consumption of each of the input files 216 (e.g., net resource consumptions 220 including a consumption value associated with each of the input files, A-I), where each of the net resource consumptions is represented as a number—1, 2, or 3. Here, a “2” corresponds to twice the net resource consumption of a “1” and a “3” corresponds to triple the net resource consumption of a 1. These per-file resource consumption metrics, along with the corresponding input file to the batch processing request 212 and input parameters to the batch processing request 212, are provided to a capacity-based load balancer 208.

Upon receipt of the batch processing request 212 and the net resource consumption 220 associated with each different file named in the batch request, the capacity-based load balancer 208 requests, from an endpoint discovery mechanism 223 of the target LLM, capacity distribution information that identifies a current fractional distribution of available capacity in a shared resource pool 202 associated with the target cloud-based model. In one implementation, the shared resource pool 202 is a pool of the compute resources available at each of multiple different model endpoints for the target cloud-based model.

In the example shown, the shared resource pool 202 includes compute resources located at different model endpoints serving different instances of the target cloud-based model named in the batch processing request 212 (e.g., textsummarization.llm). In the example shown, the shared resource pool 202 includes compute resources at three different model endpoints—Endpoint A, Endpoint B, and Endpoint C. In one implementation, each of these endpoints corresponds to a different data center serving one or more instances of the LLM (textsummarization.llm), where the data center includes computer hardware that performs the compute tasks of those instances. In different implementations, the target LLM have any number of model endpoints.

The endpoint discovery mechanism 224 communicates with an inference engine (not shown) executing on each of the model endpoints of the target LLM to discover a currently-available compute capacity at each of the model endpoints. For example, the endpoint discovery mechanism 224 obtains current GPU utilization metrics (e.g., determining which GPUs are and are not available for allocation) at each endpoint.

The endpoint discovery mechanism 224 provides the capacity-based load balancer 208 with capacity distribution information for the model endpoints, which is represented in FIG. 2 as available capacity ratio 226. The available capacity ratio 226 is indicative of a fractional distribution of the total available compute capacity in the shared resource pool across each of the model endpoints. In the example shown, 75% of the compute resources at Endpoint A are available, 50% of the compute resources at Endpoint B are available, and 25% of the compute resources at Endpoint C are available. For simplicity, it is assumed that each of the model endpoints supports an approximately equal total compute capacity. Consequently, the above percentages are usable to infer that there is twice as much available compute capacity at Endpoint B than at Endpoint C, and three times as much available compute capacity at Endpoint A than at Endpoint C—thus yielding an available capacity ratio between A:B:C of 3:2:1, as shown (equal to a fraction distribution whereby 50% of the total available capacity is at Endpoint A, 33.33% of the total available capacity is at Endpoint B, and, 16.66% of the total available capacity is at endpoint C). In actual implementations, the total compute capacity may be unevenly distributed among the model endpoints but an available capacity distribution ratio can nonetheless be similarly determined.

The capacity-based load balancer 208 uses the capacity distribution information (e.g., the available capacity ratio 226) to identify a target allocation distribution for allocating the parallelizable tasks between the model endpoints based on their respective net resource consumptions. In this case, the target allocation distribution is equal to the identified available capacity distribution characterized by the 3:2:1 ratio. The capacity-based load balancer 208 then allocates the individual parallelizable tasks of the batch processing request 212 among the model endpoints such that the total net resource consumption of the workload is distributed according to the target allocation distribution. Consequently, the parallelizable tasks are allocated such that the total net resource consumption is distributed across the model endpoints in a manner that matches or that is otherwise proportional to the fractional distribution of the available resource capacity among the multiple endpoints. In FIG. 2, this distribution is illustrated by a consumption distribution ratio 230, which matches the available capacity ratio 226.

In the example shown, the total net resource consumption of processing files A-I is “18” (with each file processing task being associated with a net resource consumption units represented in values 1, 2, or 3, with higher values indicating greater resource consumption). The capacity-based load balancer allocates these tasks according to a net resource consumption distribution consistent with the 3:2:1 available capacity ratio across endpoints A, B, and C. Here, the processing of files D-H is delegated to Endpoint A; processing of files A-C is delegated to Endpoint B; and the processing of file I is delegated to endpoint C. As illustrated by the ‘1, 2, or 3’ values associated with each file, Endpoint A receives 9 of the 18 total net resource consumption units while Endpoint B receives 6 of the 18 net resource consumption units and Endpoint C receives the remaining 3. Consequently, the net resource consumption distribution is 9:6:3, which reduces to 3:2:1 (as shown by the consumption distribution ratio 230)—a final distribution that is proportional to the available capacity ratio 226 across the model endpoints.

Notably, the above process can be repeated for batch processing requests of any size, including those with tens, hundreds, or even thousands of input files to be processed. Performing load balancing based on endpoint capacity and task-specific resource consumption as described above ensures that all of the model endpoints are saturated in an approximately equal manner, thereby maximizing utilization of the available compute resources and minimizing the time that available resources go unused.

In some implementations, the capacity-based load balancer 208 and/or consumption determination engine 206 are included in a software package provided by a same service provider that manages the endpoint discovery mechanism 224. This service provider may be different than a service provider of the LLM that benefits from the disclosed load-balancing practices. For example, the load-balancing capability is delivered in the form of a third party service package installed on the client compute platform 210 that can be used in conjunction with a variety of different LLMs. From the perspective of the service provider, it is much less expensive to perform the load-balancing on the client compute platform 210 (as shown and described above) as compared to at a centralized, cloud-based location because it end user rather than the service provider that shoulders the cost of the hardware performs the load balancing operations.

In real-time applications, the capacity distribution information for the model endpoints is subject to change over time. The capacity-based load balancer 208 constantly monitors these changes and dynamically alters the available capacity ratio 226 to reflect these changes. In real scenarios where the client workload may take hours to run, the capacity-based load balancer 208 may change the available capacity ratio 226 several times in response to detected alterations in the model endpoint capacity. With each change, the capacity-based load balancer 208 dynamically alters the target allocation distribution and begins distributing the workload tasks according to the altered target allocation distribution.

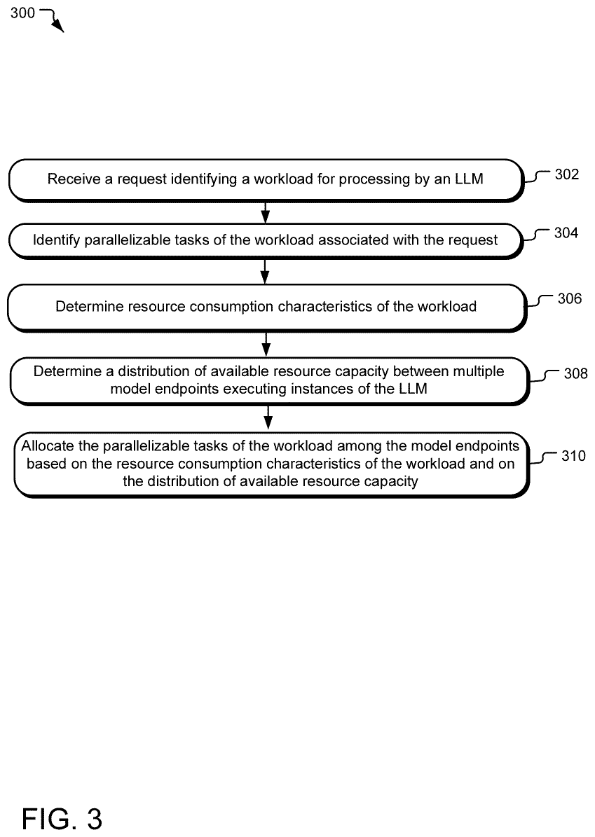

FIG. 3 illustrates example operations 300 for performing capacity-based load balancing of tasks delivered to model endpoints of a cloud-based AI model. In one implementation, the operations 300 are performed by software executing within a client compute platform, such as on one or more virtual machines configured on behalf of client user. A receiving operation 302 receives a request identifying a workload for processing by a cloud-based AI model. For example, the request is a batch processing request generated by a locally-executing client application that specifies a cloud-based transformer model by name, model type, and/or API call. An identification operation 304 identifies parallelizable tasks of the workload. In the example where the workload is a batch processing request, the processing of each different input file (e.g., of the batched files) is a parallelizable task. In other implementations, parallelizable tasks are identified based on stored characteristics of the cloud-based AI model, such as characteristics identifying the processing operations that the workload entails and/or the respective dependencies of such operations.

A determining operation 306 determines resource consumption characteristics of the workload such as the size of file(s) or other input data to be processed, a known memory footprint of the cloud-based AI model, and/or the size of the memory footprint when the model executes with a set of parameters specified in the request and over input data with characteristics matching those of the input file(s). In some implementations, the determining operation 306 further entails estimating a size of data that is to be output by the cloud-based AI model in response to processing each or all of the input file(s). In certain implementations, the resource consumption characteristics determined via the determining operation 306 are used to estimate a net resource consumption of each of the parallelizable tasks of the workload.

Another determining operation 308 determines a distribution of available resource capacity (e.g., GPU compute capacity) across multiple model endpoints that are each executing separate instances of the cloud-based AI model. For example, the determining operation 308 entails communicating with a cloud-based tool that has access to compute resource utilization information for each of the model endpoints and retrieving measurements of compute capacity collected at each of the model endpoints.

An allocation operation 310 allocates the parallelizable tasks of the workload among the model endpoints based on both the resource consumption characteristics of the workload and also based on the distribution of the available resource compacity across the model endpoints. In one implementation, allocating the parallelizable tasks of the workload entails allocating the parallelizable tasks across the model endpoints so as to distribute a total net resource consumption of the workload in a manner that matches or that is otherwise proportional to a fractional distribution of the available resource capacity across the multiple model endpoints.

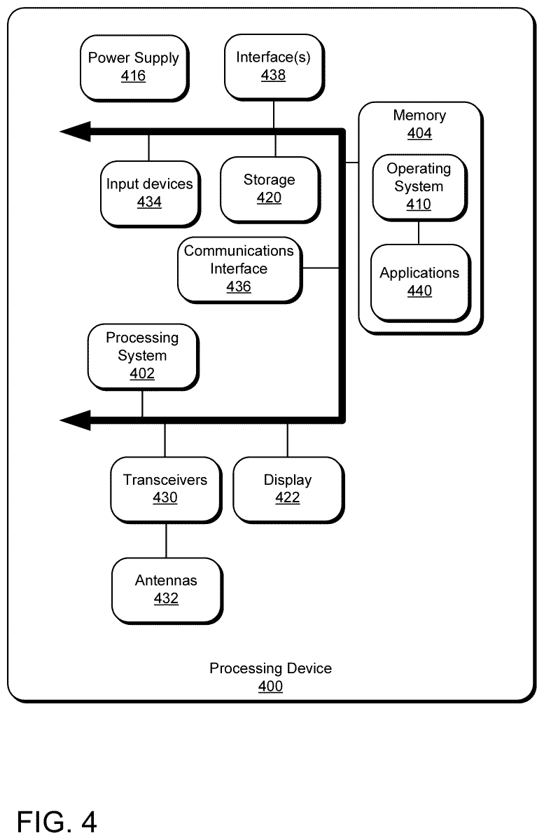

FIG. 4 illustrates an example schematic of a processing device 640 suitable for implementing aspects of the disclosed technology. The processing device 400 includes one or more processor unit(s) 402, memory device(s) 404, a display 406, and other interfaces 408 (e.g., buttons). The processor unit(s) 402 may each include one or more CPUs, GPUs, etc.

The memory device(s) 404 generally includes both volatile memory (e.g., RAM) and non-volatile memory (e.g., flash memory). An operating system 410, such as the Microsoft Windows® operating system, the Microsoft Windows® Phone operating system or a specific operating system designed for a gaming device, resides in the memory device(s) 404 and is executable by the processor unit(s) 402, although it should be understood that other operating systems may be employed.

One or more applications 412 (e.g., the client application 104 of FIG. 1, the consumption determination engine 106 of FIG. 1, the capacity-based load balancer 112 of FIG. 1, the endpoint discovery mechanism 108 of FIG. 1, or the LLM of FIG. 1) are loaded in the memory device(s) 404 and executed on the operating system 410 by the processor unit(s) 402. The applications 412 may receive inputs from one another as well as from various input local devices such as a microphone 434, input accessory 435 (e.g., keypad, mouse, stylus, touchpad, gamepad, racing wheel, joystick), and a camera 432. Additionally, the applications 412 may receive input from one or more remote devices, such as remotely-located smart devices, by communicating with such devices over a wired or wireless network using more communication transceivers 430 and an antenna 438 to provide network connectivity (e.g., a mobile phone network, Wi-Fi®, Bluetooth®). The processing device 400 may also include one or more storage devices 428 (e.g., non-volatile storage). Other configurations may also be employed.

The processing device 400 further includes a power supply 416, which is powered by one or more batteries or other power sources and which provides power to other components of the processing device 400. The power supply 416 may also be connected to an external power source (not shown) that overrides or recharges the built-in batteries or other power sources.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a system for improved utilization of compute hardware distributed among multiple endpoints of a cloud-based artificial intelligence (AI) model, the system including: a consumption determination engine stored in memory and executable to determine a net resource consumption for processing tasks in a workload generated by a client application for input to the cloud-based AI model; and a load balancer stored in the memory and executable to: determine a distribution of available resource capacity in a shared resource pool including compute resources at a plurality of model endpoints executing instances of the cloud-based AI model; and allocate parallelizable tasks of the workload among the compute resources at the multiple model endpoints based on the net resource consumption of the tasks and on the distribution of available resource capacity in the shared resource pool.

In some aspects, the techniques described herein relate to a system, wherein the parallelizable tasks of the workload are allocated among the plurality of model endpoints according to a target allocation distribution that is based on a fractional distribution of the available resource capacity across the plurality of model endpoints within the shared resource pool.

In some aspects, the techniques described herein relate to a system, wherein the target allocation distribution is a distribution of the net resource consumption of the tasks in the workload among the plurality of model endpoints that is proportional to the fractional distribution of the available resource capacity among the plurality of model endpoints.

In some aspects, the techniques described herein relate to a system, wherein the consumption determination engine is configured to: determine resource consumption characteristics of the workload; and determine the net resource consumption for each of the parallelizable tasks of the workload based on the resource consumption characteristics.

In some aspects, the techniques described herein relate to a system, wherein the cloud-based AI model is a transformer model and the net resource consumption for each of the parallelizable tasks is determined based on an identity of the transformer model and a set of inputs to the workload.

In some aspects, the techniques described herein relate to a system, wherein the net resource consumption for each of the parallelizable tasks is determined at least in part based on a size of data input to each of the parallelizable tasks and an estimated size of data output in response to processing of the data input.

In some aspects, the techniques described herein relate to a system, wherein the client application, the consumption determination engine, and the load balancer are executed within a client compute platform that communicates with a model service implementing the cloud-based AI model.

In some aspects, the techniques described herein relate to a method including: determining a net resource consumption for processing tasks in a workload generated by a client application for input to a cloud-based AI model; determining a distribution of available resource capacity in a shared resource pool including compute resources at a plurality of model endpoints executing instances of the cloud-based AI mode; and parallelizable tasks of the workload among the compute resources at the multiple model endpoints based on the net resource consumption of the tasks and on the distribution of available resource capacity in the shared resource pool.

In some aspects, the techniques described herein relate to a method, wherein the parallelizable tasks of the workload are allocated among the multiple model endpoints according to a target allocation distribution that is based on a fractional distribution of the available resource capacity across the multiple model endpoints within the shared resource pool.

In some aspects, the techniques described herein relate to a method, wherein the target allocation distribution is a distribution of the net resource consumption of the tasks in the workload among the plurality of model endpoints that is proportional to the fractional distribution of the available resource capacity among the plurality of model endpoints.

In some aspects, the techniques described herein relate to a method, further including: determining resource consumption characteristics of the workload; and determining the net resource consumption for each of the parallelizable tasks of the workload based on the resource consumption characteristics.

In some aspects, the techniques described herein relate to a method, wherein the cloud-based AI model is a transformer model and the net resource consumption for each of the parallelizable tasks is determined based on an identity of the transformer model and a set of inputs to the workload.

In some aspects, the techniques described herein relate to a method, wherein the net resource consumption for each of the parallelizable tasks is determined at least in part based on a size of data input to each of the parallelizable tasks and an estimated size of data output in response to processing of the data input.

In some aspects, the techniques described herein relate to a method, wherein the workload is a batch processing request and the method further including determining a net resource consumption associated with processing each of multiple different files.

In some aspects, the techniques described herein relate to one or more tangible computer-readable storage media encoding processor-executable instructions for executing a computer process including: determining a net resource consumption for processing tasks in a workload generated by a client application for input to a cloud-based AI model; determining a distribution of available resource capacity in a shared resource pool including compute resources at a plurality of model endpoints executing instances of the cloud-based AI mode; and parallelizable tasks of the workload among the compute resources at the multiple model endpoints based on the net resource consumption of the tasks and on the distribution of available resource capacity in the shared resource.

In some aspects, the techniques described herein relate to one or more tangible computer-readable storage media, wherein the parallelizable tasks of the workload are allocated among the multiple model endpoints according to a target allocation distribution that is based on a fractional distribution of the available resource capacity across the multiple model endpoints within the shared resource pool.

In some aspects, the techniques described herein relate to one or more tangible computer-readable storage media, wherein the target allocation distribution is a distribution of the net resource consumption of the tasks in the workload among the plurality of model endpoints that is proportional to the fractional distribution of the available resource capacity among the plurality of model endpoints.

In some aspects, the techniques described herein relate to one or more tangible computer-readable storage media, wherein the computer process further including: determining resource consumption characteristics of the workload; and determining the net resource consumption for each of the parallelizable tasks of the workload based on the resource consumption characteristics.

In some aspects, the techniques described herein relate to one or more tangible computer-readable storage media, wherein the net resource consumption for each of the parallelizable tasks is determined at least in part based on a size of data input to each of the parallelizable tasks and an estimated size of data output in response to processing of the data input.

In some aspects, the techniques described herein relate to one or more tangible computer-readable storage media, wherein the cloud-based AI model is a transformer model and the net resource consumption for each of the parallelizable tasks is determined based on an identity of the transformer model and a set of inputs to the workload.

In some aspects, the techniques described herein relate to a system for improved utilization of compute hardware distributed among multiple endpoints of a cloud-based artificial intelligence (AI) model, the system including: a means for determining a net resource consumption for processing tasks in a workload generated by a client application for input to the cloud-based AI model; a means for determining a distribution of available resource capacity in a shared resource pool including compute resources at a plurality of model endpoints executing instances of the cloud-based AI model; and a means for allocating parallelizable tasks of the workload among the compute resources at the multiple model endpoints based on the net resource consumption of the tasks and on the distribution of available resource capacity in the shared resource pool.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A system for improved utilization of compute hardware distributed among a plurality of endpoints of a cloud-based service operating a trained machine learning model, the system comprising:
a consumption determination engine stored in memory and executable to determine a net resource consumption for processing tasks in a workload generated by a client application for input to the trained machine learning model; and
a load balancer stored in the memory and executable to:
determine a distribution of available resource capacity in a shared resource pool comprising compute resources at the plurality of model endpoints executing instances of the trained machine learning model; and
allocate parallelizable tasks of the workload among the compute resources at the multiple model endpoints based on the net resource consumption of the tasks and on the distribution of available resource capacity in the shared resource pool.

2. The system of claim 1, wherein the parallelizable tasks of the workload are allocated among the plurality of model endpoints according to a target allocation distribution that is based on a fractional distribution of the available resource capacity across the plurality of model endpoints within the shared resource pool.

3. The system of claim 2, wherein the target allocation distribution is a distribution of the net resource consumption of the tasks in the workload among the plurality of model endpoints that is proportional to the fractional distribution of the available resource capacity among the plurality of model endpoints.

4. The system of claim 1, wherein the consumption determination engine is configured to:
determine resource consumption characteristics of the workload; and
determine the net resource consumption for each of the parallelizable tasks of the workload based on the resource consumption characteristics.

5. The system of claim 4, wherein the trained machine learning model is a transformer model and the net resource consumption for each of the parallelizable tasks is determined based on an identity of the transformer model and a set of inputs to the workload.

6. The system of claim 4, wherein the net resource consumption for each of the parallelizable tasks is determined at least in part based on a size of data input to each of the parallelizable tasks and an estimated size of data output in response to processing of the data input.

7. The system of claim 1, wherein the load balancer determines the distribution of available resource capacity by requesting, from an endpoint discovery mechanism, capacity measurements pertaining to availability of compute resources supporting execution of the model instances at the model endpoints, the endpoint discovery mechanism being configured to retrieve the capacity measurements from the model endpoints.

8. A method for improved utilization of compute hardware distributed among multiple model endpoints of a cloud-based service operating a trained machine learning model, the method comprising:
determining a net resource consumption for processing tasks in a workload generated by a client application for input to the trained machine learning model;
determining a distribution of available resource capacity in a shared resource pool comprising compute resources the a plurality of model endpoints executing instances of the trained machine learning model; and
allocating parallelizable tasks of the workload among the compute resources at the multiple model endpoints based on the net resource consumption of the tasks and on the distribution of available resource capacity in the shared resource pool.

9. The method of claim 8, wherein the parallelizable tasks of the workload are allocated among the multiple model endpoints according to a target allocation distribution that is based on a fractional distribution of the available resource capacity across the multiple model endpoints within the shared resource pool.

10. The method of claim 9, wherein the target allocation distribution is a distribution of the net resource consumption of the tasks in the workload among the plurality of model endpoints that is proportional to the fractional distribution of the available resource capacity among the plurality of model endpoints.

11. The method of claim 8, further comprising:
determining resource consumption characteristics of the workload;
determining the net resource consumption for each of the parallelizable tasks of the workload based on the resource consumption characteristics; and
requesting capacity measurements pertaining to availability of compute resources supporting execution of the model instances at the model endpoints.

12. The method of claim 11, wherein the trained machine learning model is a transformer model and the net resource consumption for each of the parallelizable tasks is determined based on an identity of the transformer model and a set of inputs to the workload.

13. The method of claim 11, wherein the net resource consumption for each of the parallelizable tasks is determined at least in part based on a size of data input to each of the parallelizable tasks and an estimated size of data output in response to processing of the data input.

14. The method of claim 8, wherein the workload is a batch processing request and the method further comprising determining a net resource consumption associated with processing each of multiple different files.

15. One or more tangible computer-readable storage media encoding processor-executable instructions for executing a computer process for improved utilization of compute hardware distributed among a plurality of model endpoints of a cloud-based service operating a trained machine learning model, the computer process comprising:
determining a net resource consumption for processing tasks in a workload generated by a client application for input to the trained machine learning model;
determining a distribution of available resource capacity in a shared resource pool comprising compute resources at the plurality of model endpoints executing instances of the cloud-based AI mode; and
allocating parallelizable tasks of the workload among the compute resources at the multiple model endpoints based on the net resource consumption of the tasks and on the distribution of available resource capacity in the shared resource.

16. The one or more tangible computer-readable storage media of claim 15, wherein the parallelizable tasks of the workload are allocated among the multiple model endpoints according to a target allocation distribution that is based on a fractional distribution of the available resource capacity across the multiple model endpoints within the shared resource pool.

17. The one or more tangible computer-readable storage media of claim 16, wherein the target allocation distribution is a distribution of the net resource consumption of the tasks in the workload among the plurality of model endpoints that is proportional to the fractional distribution of the available resource capacity among the plurality of model endpoints.

18. The one or more tangible computer-readable storage media of claim 15, wherein the computer process further comprises:
determining resource consumption characteristics of the workload;
determining the net resource consumption for each of the parallelizable tasks of the workload based on the resource consumption characteristics; and
requesting capacity measurements pertaining to availability of compute resources supporting execution of the model instances at the model endpoints.

19. The one or more tangible computer-readable storage media of claim 18, wherein the net resource consumption for each of the parallelizable tasks is determined at least in part based on a size of data input to each of the parallelizable tasks and an estimated size of data output in response to processing of the data input.

20. The one or more tangible computer-readable storage media of claim 18, wherein the trained machine learning model is a transformer model and the net resource consumption for each of the parallelizable tasks is determined based on an identity of the transformer model and a set of inputs to the workload.
